(19) United States
(12) Patent Application Publication
(10) Pub. No.: US 2003/0026319 A1
(43) Pub. Date: Feb. 6, 2003

(54) Differential scanning calorimeter

(76) Inventor: Ryoichi Kinoshita, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 10/194,589

(22) Filed: Jul. 12, 2002

(30) Foreign Application Priority Data
Aug. 3, 2001 (JP) 2001-236209

(51) Int. Cl. G01K 17/00

(52) U.S. Cl. 374/31; 374/33

(57) ABSTRACT

To provide a differential scanning calorimeter in which rise and fall of temperatures of a sample and a reference substance follow rise and fall of temperature of a heat sink with excellent response maintaining a structure of a differential scanning calorimeter having a structure of providing stability of a base line constituting a characteristic of a heat flux type while achieving response equivalent to or faster than that of a power compensation type, in a structure of a heat flux type differential scanning calorimeter in which a heat flow path between a sample holder and a heat sink is formed by a metallic material having excellent heat conductance, heaters for power compensation are attached to the sample holder and a reference holder.

### BACKGROUND OF THE INVENTION

1. Field of the Invention

The present invention relates to a thermal analysis apparatus for measuring how a physical or chemical property of a sample is changed with temperature, particularly to a differential scanning calorimeter for measuring and analyzing heat flow which a sample superfluously generates or absorbs in comparison with a reference substance when temperature is changed at a constant rate.

2. Description of the Related Art

A differential scanning calorimeter is an apparatus for symmetrically arranging a sample and a reference substance (thermally stable reference substance, normally, alumina or the like is used) and differentially detecting and analyzing heat flow which a sample superfluously generates or absorbs in comparison with a reference substance when temperatures of both are changed at a constant rate.

When temperature of a sample is elevated at a constant rate, heat absorption by the sample is increased with an increase in a heat capacity of the sample. That is, an absolute value of a different heat flow signal is increased. In this case, the absolute value of the different heat flow signal is proportional to a difference between heat capacities of the sample and a reference and a temperature rise rate and therefore, the heat capacity of the sample can be known from the differential heat flow signal based on the known temperature rise rate and the known heat capacity of the reference.

Meanwhile, when a sample is melted, heat absorption by the sample is temporarily increased and when a differential heat flow signal recorded time-sequentially is represented by a graph, the differential heat flow signal draws a heat absorption peak. Further, in accordance with a similar recording method, when crystallization is caused in the sample, the differential heat flow signal draws a heat generation peak. An area of the heat absorption or generation peak drawn with respect to time axis which is set such that unit time corresponds to a constant length, is proportional to a quantity of heat (heat of transition) discharged or absorbed by the sample in transition and therefore, when previously known transition heat is measured and a signal value is corrected, the transition heat of the sample can easily be calculated from the differential heat flow signal. A differential scanning calorimeter is widely used in analyzing various materials since the differential heat flow signal having the above-described useful property is obtained.

Conventional differential scanning calorimeters are grossly classified into two kinds shown below.

One of them is referred to as a power compensation type and is constituted by combining two independent calorimeters for sample and for reference which are formed symmetrically and each of them is provided with a resistor temperature sensor and a heater for feeding back heat flow. An average value of temperatures detected by the two temperature sensors, is compared with a temperature output of a temperature programmer which is changed at a constant rate and the two calorimeters are heated by heaters for feeding back heat flow such that the average value and the temperature output coincides with each other. Further, when a difference is produced between the temperature outputs of the two temperature sensors, powers of the two heaters are added or subtracted immediately such that the difference is reset to null. At this occasion, a difference between the powers supplied to the two heaters at every second, is recorded as a differential heat flow signal. The differential scanning calorimeter of the power compensation type is excellent in response and can realize a heat compensation time constant equal to or shorter than 2 seconds.

Other thereof is referred to as a heat flux type and temperature sensors for sample and for reference are fixed to inner portions of a heat sink formed by an excellent conductor of heat to form symmetrical and equal heat flow paths. Temperature of the heat sink is compared with a temperature output of a temperature programmer which is changed at a constant rate and a feedback control is carried out by a heater wound around the heat sink such that the temperature and the temperature output coincides with each other. A temperature difference between the sample and the reference is detected by a differential thermocouple. In this case, when the temperature difference between the sample and the reference is divided by heat resistance between the heat sink and the sample, by a way similar to that in calculating current by dividing potential difference by resistance, differential heat flow constituting a difference between heat flows to the sample and the reference can be calculated. That is, according to the differential scanning calorimeter of the heat flux type, an output of the differential thermocouple representing the temperature difference between the sample and the reference is pertinently amplified and outputted and recorded as a differential heat flow signal.

Although the differential scanning calorimeter of the heat flux type is excellent in base line stability, the calorimeter is provided with the heat compensation time constant normally exceeding 3 seconds and therefore, there are drawbacks that a peak of the heat flow signal is blunted and separation of a plurality of peaks is deteriorated. Although the power compensation type can realize the heat compensation time constant equal to or shorter than 2 seconds, with regard to a base line function, stability comparable to that of the differential scanning calorimeter of the heat flux type is difficult to achieve. The maximum reason is that the power compensation type sensor causes a significant temperature difference with a surrounding member in measuring, as a result, a comparatively large amount of heat leakage is incessantly produced from the sensor to an outside field to constitute a factor of drift in the base line.

Meanwhile, with an object of resolving the drawbacks of the differential scanning calorimeters of the two systems, there is disclosed a constitution of a type of combining a detector of the power compensation type and a heat sink formed by an excellent conductor of heat constituting the characteristic of the heat flux type. According to Japanese Patent Laid-Open No. 160261/1999, there is disclosed a differential scanning calorimeter of a structure comprising a temperature measuring circuit for fixing a detector comprising an insulating board provided with a symmetrical circuit pattern by a metallic resistor at an inner portion of a heat sink formed by an excellent conductor of heat and measuring temperature of the detector by detecting a resistance value of the metallic resistor at inside of the detector, a differential heat detecting circuit for detecting a temperature difference between a sample and a reference mounted to the detector by comparing resistance values of a pair of symmetrical metallic resistor circuits at inside of the detector, and a differential heat compensating circuit for making pertinent current flow to respectives of the pair of symmetrical metallic resistors at inside of the detector such that an output of the differential heat detecting circuit is incessantly rest to null for achieving stability of a base line constituting the characteristic of the heat flux type while achieving response equivalent to or faster than that of the power compensation type.

In the case of the structure of fixing the detector comprising the insulating board provided with the symmetrical circuit pattern by the metallic resistor to the inner portion of the heat sink formed by the excellent conductor of heat as disclosed in Japanese Patent Laid-Open No. 160261/1999, a sample vessel is installed above the metallic resistor and rise and fall of temperature of the sample is carried out by flow in and flow out of heat from and to the heat sink by way of the insulating board and the metallic resistor. The insulating board is an electrically insulating board and heat conducting performance of an electrically insulating material is generally inferior to that of an electrically conductive material. Rise and fall of temperature of the sample is carried out by way of the insulating board having inferior heat conducting performance as a path of flow in and flow out of heat and therefore, there is a drawback that delay is liable to cause in comparison with rise and fall of temperature of the heat sink.

### SUMMARY OF THE INVENTION

A differential scanning calorimeter of the present invention has a structure of providing stability of a base line constituting a characteristic of a heat flux type while achieving response equivalent to or faster than that of a power compensation type.

Further, the differential scanning calorimeter of the present invention has a structure in which heaters for power compensation are attached to surfaces or rear faces of the sample holder and the reference holder via thin electrically insulating layers, or a structure in which lead wires are attached to the sample holder and the reference holder and the heaters for power compensation are constituted by the respective holders per se in a heat flux type differential scanning calorimeter having a heat flow path between a holder for installing a sample vessel and a heat sink made of a metallic material having excellent heat conductance, carries out flow in and flow out of heat by arranging the sample holder and a reference holder at symmetrical positions, and detects a temperature difference between the sample holder and the reference holder

The heaters attached to the surfaces or the rear faces of the sample holder and the reference holder via the thin electrically insulating layers as the heaters for power compensation, are supplied with powers independently from each other by a differential heat compensating circuit and controlled to reset a temperature difference between the sample holder and the reference substance holder to null. As a result, a difference in absorbing or generating heat of the sample as compared with that of the reference substance, is always detected as a difference between power consumptions at heaters individually provided at the sample holder and the reference holder to thereby achieve a function of a differential scanning calorimeter of a power compensation type. Meanwhile, the sample and the reference substance are installed at the sample holder and the reference holder symmetrically arranged and temperatures of both are controlled by heat conduction from the heat sink temperature of which is controlled via the heat flow path formed by a metallic material in accordance with programmed temperature to thereby form a structure of a heat flux type differential scanning calorimeter which is easy to provide the stability of the base line. Flow in and flow out of heat from the heat sink to the sample and the reference substance at this occasion is carried out by way of the metallic material having excellent heat conduction and therefore, rise and fall of temperatures of the sample and the reference substance follow to rise and fall of temperature of the heat sink with excellent response.

### BRIEF DESCRIPTION OF THE DRAWING

FIG. 1 is a block diagram partially including a sectional view showing an embodiment of the invention.

### DETAILED DESCRIPTION OF THE INVENTION

A detailed explanation will be given of an embodiment of the invention in reference to the drawing shown in an example as follows.

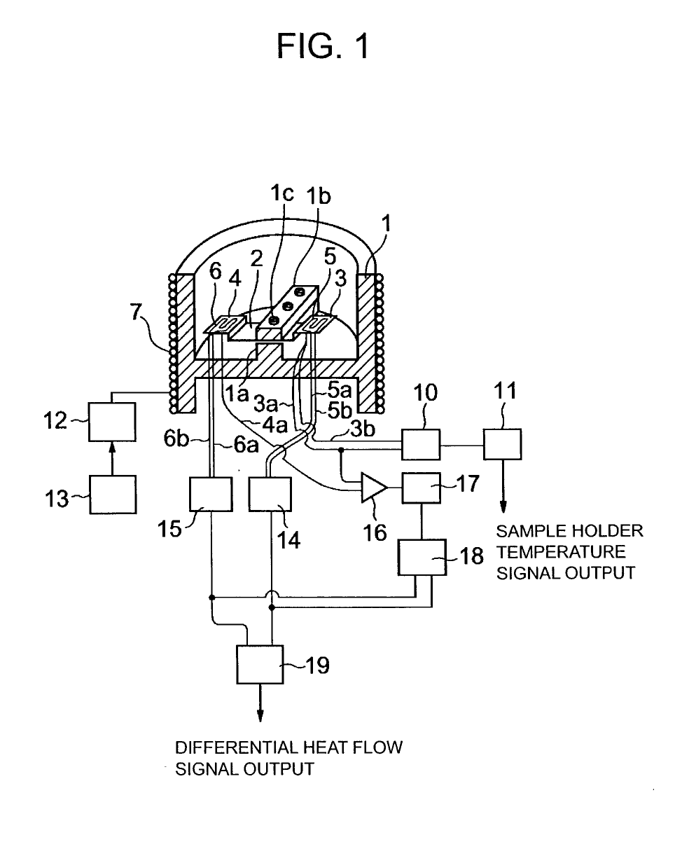

FIG. 1 shows a constitution view of a differential scanning calorimeter according to the invention. Numeral 1 designates a heat sink made of silver constituting an excellent conductor of heat and the heat sink is formed in a cylindrical shape and a section thereof constitutes substantially an H-like shape and a jut portion 1a in a projected shape is formed at center of a bottom portion thereof. The heat sink is shown by a sectional view for easy to understand the structure. Numeral 2 designates a heat flow path in a shape of a long plate made of a metallic material (constantan is used in the embodiment), a center portion thereof is sandwiched between an upper face of the jut portion 1a in the projected shape at the center of the bottom portion of the heat sink and a hold plate 1b made of silver and is fixed onto the upper face of the jut portion 1a in the projected shape at the center of the bottom portion of the heat sink along with the hold plate 1b by a plurality of screws 1c. Further, two front ends of the heat flow path 2 are folded to bend in a step-like shape and produce regions in a planar shape for respectively constituting a sample holder 3 and a reference substance holder 4. The sample holder 3 and the reference holder 4 are symmetrically arranged from the central portion fixed onto the jut portion 1a in the projected shape. Rear faces of the sample holder 3 and the reference substance holder 4 are respectively welded with plates made of chromel (not illustrated), further, the chromel plate at the rear face of the sample holder 3 is welded with a chromel line 3a and an alumel line 3b and the chromel plate at the rear face of the reference substance holder 4 is welded with a chromel line 4a. There are junctions of chromel-constantan respectively at the rear face of the sample holder 3 and the rear face of the reference substance holder 4 and the sample holder 3 and the reference substance holder 4 are communicated with each other by the heat flow path 2. Therefore, connection of the chromel line 3a, the chromel plate, the sample holder 3, the heat flow path 2, the reference substance holder 4, the chromel plate and the chromel line 4a, forms a differential thermocouple of chromel-constantan-chromel and thermoelectromotive force in correspondence with a temperature difference between the sample holder 3 and the reference substance holder 4 constituting the junction points, is outputted between the chromel line 3a and the chromel line 4a.

Meanwhile, the chromel line 3a and the alumel line 3b form a thermocouple at the rear face of the sample holder 3 and output temperature of the sample holder 3 via a cold junction circuit 10 and a thermoelectromotive force/temperature conversion circuit 11.

An insulatively coated furnace temperature control heater 7 is wound around an outer periphery of the heat sink 1. A furnace temperature control circuit 12 is connected to a program temperature function generator 13 for generating a programmed temperature signal for thermal analysis and the furnace temperature control circuit 12 pertinently controls an output of the furnace temperature control heater 7 connected to the furnace temperature control circuit 12 to thereby control temperature of the heat sink 1 to change in correspondence with the program temperature function.

When a sample vessel (not illustrated) inputted with a sample and a reference substance vessel (not illustrated) inputted with a reference substance are respectively installed above the sample holder 3 and the reference holder 4 and temperature of the heat sink 1 is changed in correspondence with the program temperature function, an input of heat flow is symmetrically carried out to the sample holder 3 and the reference substance holder 4 from the jut portion 1a in the projected shape at the center of the bottom portion of the heat sink via the heat flow path 2, as a result, temperatures of the sample vessel (not illustrated) inputted with the sample and the reference substance vessel (not illustrated) inputted with the reference substance, are changed to follow a change in the temperature of the heat sink 1.

A temperature difference between the sample holder 3 and the reference substance holder 4 in accordance with the change in the temperature, is outputted as a difference between thermoelectromotive forces of the chromel line 3a and the chromel line 4a. Further, the temperature of the sample holder 3 is outputted as thermoelectromotive force between the chromel line 3a and the alumel line 3b and is outputted as a temperature signal by way of the cold junction circuit 10 and the thermoelectromotive force/temperature conversion circuit 11.

The structure constructs a constitution of a differential scanning calorimeter of a heat flux type.

Surroundings of the sample and the reference substance are surrounded by the heat sink 1 temperature of which is controlled and the input of heat flow is symmetrically carried out via the determined heat flow path 2 and therefore, when there is not a thermal change of phase transition or the like in both of the sample and the reference substance, an output of a temperature difference between the sample holder 3 and the reference holder 4 (corresponding to base line) becomes very stable.

A surface of the sample holder 3 is provided with a thin electrically insulating layer (not illustrated) and a heater pattern 5 (sample side heater) in a shape of a thin film is provided further thereon. Similarly, a surface of the reference holder 4 is also provided with a thin electrically insulating layer (not illustrated) and a heater pattern 6 (reference side heater) in a shape of a thin film is provided further thereon. According to the embodiment, the thin electrically insulating layer is formed with an alumina thin film by a sputtering process and is formed with a heater pattern of platinum further thereon by a sputtering process further thereon. Further, a thin alumina layer is formed again further thereon to thereby constitute electric insulation from the sample vessel installed thereabove.

Further, although according to the embodiment, the thin electrically insulating layer is indicated by the alumina thin film by sputtering, so far as the thin electrically insulating layer is a thin layer constituting electric insulation from the sample holder 3, the thin electrically insulating layer may be formed by a thin oxide film on the surface of the holder or the thin electrically insulating layer may be formed by glass coating. Further, although according to the embodiment, an explanation has been given of the heater pattern 5 by the pattern of platinum, the heater pattern 5 may be formed by a heater material capable of being produced in close contact on the electrically insulating layer. Lead wires 5a and 5b and 6a and 6b are respectively led out from the sample side heater pattern 5 and the reference side heater pattern 6, the lead wires 5a and 5b are connected to a sample side heater current control circuit 14 and the lead wires 6a and 6b are connected to a reference side heater current control circuit 15.

Meanwhile, the signal of the temperature difference between the sample holder 3 and the reference holder 4 is inputted to a thermoelectromotive force difference/temperature difference conversion circuit 17 via an amplifier 16 connected to the chromel line 3a and the chromel line 4a and is further inputted to a differential heat compensating circuit 18. The differential heat compensating circuit 18 is connected to the sample side heater current control circuit 14 and the reference substance side heater current control circuit 15 and supplies pertinent current to the sample side heater pattern 5 and the reference side heater pattern 6 to reset the temperature difference between the sample holder 3 and the reference holder 4 to null. A calculator 19 is connected to the sample side heater current control circuit 14 and the reference substance side heater current control circuit 15 and calculates a difference between power consumptions per time respectively consumed by the sample side heater pattern 5 and the reference side heater pattern 6 based on outputs of the two circuits 14 and 15 and outputs the difference as a differential heat flow signal.

Next, an explanation will be given of operation according to the embodiment. A measuring person installs a sample vessel (not illustrated) filled with a sample intended to measure and a reference substance vessel (not illustrated) filled with a reference substance thermal stability of which has been confirmed in a temperature range intended to measure to the sample holder 3 and the reference holder 4. When start of measurement is instructed thereafter, first, certain constant current is supplied from the reference side heater current control circuit 15 to the reference side heater pattern 6. Although the temperature of the reference substance side holder is slightly elevated in accordance therewith, since input of heat flow is swiftly carried out to the heat sink 1 via the heat flow path 2 having excellent heat conductance, a steady-state temperature distribution is swiftly realized between the reference side holder and the heat sink. Meanwhile, the temperature difference between the sample holder 3 and the reference holder 4 produced in accordance with temperature rise of the reference side holder 4, is inputted to the differential heat compensating circuit 18 via the amplifier 16 and the thermoelectromotive force difference/temperature difference converter 17. At the differential heat compensating circuit 18, pertinent current is supplied to the sample side heater current control circuit 14 to reset the temperature difference to null. In accordance with swift realizing of the steady-state temperature distribution between the reference side holder and the heat sink, a steady-state temperature distribution between the sample holder and the heat sink is also realized swiftly and a differential heat flow signal from the calculator 19 connected to the sample side heater current control circuit 14 and the reference side heater current control side 15, is swiftly outputted stably.

Meanwhile, with start of measurement, in accordance with the programmed temperature signal from the program temperature function generator 13, the furnace temperature control circuit 12 pertinently controls the output of the furnace temperature control heater 7 to thereby control the temperature of the heat sink 1 to change in accordance with the program temperature function. In accordance with the temperature change of the heat sink 1, input of heat flow is swiftly carried out symmetrically to the sample holder 3 and the reference holder 4 from the jut portion 1a in the projected shape at the center of the bottom portion of the heat sink by way of the heat flow path 2, as a result, the temperatures of the sample vessel (not illustrated) inputted with the sample and the reference substance vessel (not illustrated) inputted with the reference substance, are swiftly changed to follow the temperature change of the heat sink 1. When there is caused a change in the temperature difference between the sample holder 3 and the reference holder 4 in correspondence with the change in the temperature difference, the temperature change is swiftly controlled by operation of the differential heat compensating circuit 18. The output of the temperature difference between the sample holder 3 and the reference substance holder 4 becomes very stable when there is not a thermal change of phase transition or the like both in the sample and the reference substance and therefore, as a result, supply of current to the sample side heater current control circuit 14 by operation of the differential heat compensating circuit 18, also becomes very stable and the differential heat flow signal from the calculator 19 is stably outputted. That is, there is provided stable base line constituting the characteristic of the heat flux type differential scanning calorimeter.

Further, in comparison with the structure of the conventional example in which input of heat flow is carried out to the sample vessel by way of the insulating board having inferior heat conduction, according to the embodiment in which the heat flow path is formed by the metallic material having excellent heat conduction, it is apparent that the temperature change of the sample vessel following the temperature change of the heat sink is carried out swiftly.

Meanwhile, when there is produced a thermal change of phase transition or the like in the sample in accordance with temperature rise, the temperature difference is produced between the sample holder 3 and the reference holder 4 and therefore, current is supplied swiftly to the sample side heater current control circuit 14 to reset the temperature difference to null by operation of the differential heat compensating circuit 18 and as a result, heat supply is carried out to the sample at inside of the sample vessel by way of the sample holder 3. When the transition of the sample is finished, the temperature difference is also reduced rapidly and therefore, heat supply to the sample holder 3 is rapidly reduced and the steady state is recovered.

It is apparent that a thermal distance between the sample side heater pattern 5 provided at the surface of the holder and the sample vessel at this occasion, is shorter than a distance from the jut portion 1a in the projected shape at the center of the bottom portion of the heat sink to the sample vessel by way of the heat flow path 2 and therefore, heat supply from the sample side heater pattern 5 is far faster than heat supply from the heat sink according to the operational principle of the heat flux type. Therefore, there is realized fast response of the power compensation type with regard to the thermal change of the sample.

Although according to the embodiment, an explanation has been given of the differential scanning calorimeter having the heat flow path formed by the metallic material in the shape of the long plate fixed to the jut portion 1a in the projected shape at the center of the bottom portion of the heat sink having the structure shown in FIG. 1, it is apparent that an effect similar to that of the invention is achieved by an apparatus having a structure of a heat flux type differential scanning calorimeter using a metallic material having excellent heat conductance in a heat flow path and a structure in which a heater for power compensation is attached to a surface or a rear face of each of a sample holder and a reference holder via a thin electrically insulating layer. For example, a similar effect is achieved by a structure having a heat flow path in a shape of a circular disk made of a metal or a structure formed with a heat flow path by a metal column.

Further, although according to the embodiment, an explanation has been given of the example having the structure in which the separate heater for power compensation is attached to the surface of the sample holder, a similar effect is achieved by a structure in which a lead wire is directly attached to a holder portion and the lead wire is respectively connected to a heater current control circuit in order to operate a holder material per se as a heater for power compensation.

As described above, in the differential scanning calorimeter combined with the structure of the heat flux type providing the stable base line and the power compensation type providing fast response to the thermal change of the sample, whereas conventionally, there is a delay of the temperature of the sample in following the temperature change of the heat sink since the insulating board having inferior heat conductance is used in the heat flow path for carrying out input of heat flow from the heat sink to the sample vessel, according to the invention, by using the metallic material having excellent heat conductance in the heat flow path, there is achieved an effect of substantially eliminating the delay of the sample temperature in following to the temperature change of the heat sink without losing the stability of the base line and the fast response of the power compensation type and there is achieved an effect capable of realizing the differential scanning calorimeter substantially excellent in performance of following rise and fall of temperature.

Further, by operating the holder portion as a heater for power compensation while maintaining the structure of the heat flux type differential scanning calorimeter having excellent base line stability and using the metallic material having excellent heat conductance in the heat flow path, there also is achieved an effect simply and conveniently promoting response to the thermal change of the sample while maintaining the stability of the base line.

What is claimed is:

1. A differential scanning calorimeter comprising:
a heat sink made of an excellent conductor of heat and having a space for containing a sample and a reference substance at an inner portion thereof;
a program temperature function generator for outputting a temperature target value at respective time;
a heat sink temperature controller for controlling a temperature of the heat sink in accordance with an output of the program temperature function generator;
a sample holder and a reference holder for mounting the sample and the reference substance;
a heat flow path made of a metallic material provided between the heat sink and the sample holder and between the heat sink and the reference holder; and
a temperature difference detector provided at the sample holder and the reference holder for detecting a temperature difference between the sample holder and the reference holder;
wherein a sample side heater and a reference side heater are attached to surfaces or rear faces of the sample holder and the reference holder respectively via thin electrically insulating layers, comprising:
a differential heat compensating circuit for inputting a temperature difference signal detected by the temperature difference detector and outputting a current to the sample side heater and the reference heater to reset the temperature difference to null; and
a calculator for calculating a difference between power consumptions at the sample side heater and the reference side heater from an output of the differential heat compensating circuit, an output from the calculator being outputted as a differential heat flow signal.

2. A differential scanning calorimeter comprising:
made of a heat sink comprising an excellent conductor of heat and having a space for containing a sample and a reference substance at an inner portion thereof;
a program temperature function generator for outputting a temperature target value at respective time;
a heat sink temperature controller for controlling a temperature of the heat sink in accordance with an output of the program temperature function generator;
a sample holder and a reference holder for mounting the sample and the reference substance;
a heat flow path made of a metallic material provided between the heat sink and the sample holder and between the heat sink and the reference holder; and
a temperature difference detector provided at the sample holder and the reference holder for detecting a temperature difference between the sample holder and the reference holder;
wherein in order to operate the sample holder and the reference holder respectively as heaters for power compensation, comprising:
lead wires connected to the sample holder and the reference holder;
a sample side heater current control circuit connected to the lead wire from a side of the sample holder;
a reference side heater current control circuit connected to the lead wire from a side of the reference holder;
a differential heat compensating circuit connected to the temperature difference detector, the differential heat compensating circuit being connected to the sample side heater current control circuit and the reference side heater current control circuit and controlling of making a current flow respectively to the sample holder and the reference holder to reset the temperature difference to null based on a temperature difference signal detected by the temperature difference detector; and
a calculator for calculating a difference between power consumptions at the sample holder and the reference substance holder from an output of the differential heat compensating circuit, an output from the calculator being outputted as a differential heat flow signal.
